(19) United States
(12) Patent Application Publication
(10) Pub. No.: US 2026/0065817 A1
(43) Pub. Date: Mar. 5, 2026

(54) DISPLAY APPARATUS AND VEHICLE

(71) Applicant: Sharp Display Technology Corporation, Kameyama City (JP)

(72) Inventor: Masashi MAYUMI, Kameyama City (JP)

(21) Appl. No.: 19/309,933

(22) Filed: Aug. 26, 2025

(30) Foreign Application Priority Data
Aug. 29, 2024 (JP) 2024-147926

(51) Int. Cl. G09G 3/00; G06F 3/041; G06F 3/042; G06F 3/044

(52) U.S. Cl. CPC G09G 3/001; G06F 3/0416; G06F 3/042; G06F 3/044; G06F 2203/04108; G09G 2320/068; G09G 2354/00; G09G 2380/10

(57) ABSTRACT

A display apparatus includes a display panel including a display region; a proximity sensor including a capacitive sensor having a plurality of sensor electrodes superimposed on the display region in a plan view and enabled to detect approach of an operator to each of the sensor electrodes or an infrared sensor enabled to detect the approach of the operator to each of zones into which the display region is segmented; a touch sensor superimposed on the display region in a plan view; and a controller. The controller includes an operator identification unit that determines whether the operator is a first user or a second user; and a touch processor that performs a first process if the operator is identified to be the first user or a second process if the operator is identified to be the second user, with the second process at least partially different from the first process.

### BACKGROUND

### 1. Field

The present disclosure relates to a display apparatus and a vehicle.

### 2. Description of the Related Art

Japanese Unexamined Patent Application Publication No. 2009-241707 discloses an operator determination apparatus that determines whether an operator sits in a driver's seat or a passenger's seat.

Reference is made to Japanese Unexamined Patent Application Publication No. 2009-241707 (published on Oct. 22, 2009).

The configuration disclosed in Japanese Unexamined Patent Application Publication No. 2009-241707 includes multiple sensors in a frame region of a display apparatus and each of the sensors includes a transmitter and a receiver of ultrasonic waves. Narrowing the frame region may thus be difficult.

### SUMMARY

According to a first aspect of the disclosure, there is provided a display apparatus including: a display panel including a display region; a proximity sensor including (i) a capacitive sensor having a plurality of sensor electrodes superimposed on the display region in a plan view and enabled to detect approach of an operator to each of the sensor electrodes or (ii) an infrared sensor enabled to detect the approach of the operator to each of zones into which the display region is segmented; a touch sensor superimposed on the display region in a plan view; and a controller, wherein the controller includes a proximity receiver that receives proximity information from the proximity sensor; a touch receiver that receives touch information from the touch sensor; an operator identification unit that determines in accordance with the proximity information whether the operator is a first user who views the display panel from a first side or a second user who views the display panel from a second side opposite to the first side; and a touch processor that performs a first process corresponding to the touch information if the operator is identified to be the first user or a second process corresponding to the touch information if the operator is identified to be the second user, with the second process at least partially different from the first process.

According to another aspect of the disclosure, there is provided a vehicle including the display apparatus according to the first aspect of the disclosure.

### BRIEF DESCRIPTION OF THE DRAWINGS

FIG. 1 illustrates users viewing a display apparatus of an embodiment of the disclosure together with a plan view of an example of the configuration of the display apparatus;

FIG. 2 illustrates the users viewing the display apparatus of the embodiment of the disclosure together with a plan view of another example of the configuration of the display apparatus;

FIG. 3 is a partial cross-sectional view illustrating the example of the configuration of the display apparatus illustrated in FIG. 1;

FIG. 4 is a diagram illustrating an example of zone segmentation performed by an infrared sensor illustrated in FIG. 2;

FIG. 5 is a plan view illustrating a mounting example of the infrared sensor illustrated in FIG. 2;

FIG. 6 is a plan view illustrating a mounting example of the infrared sensor illustrated in FIG. 2;

FIG. 7 is a plan view illustrating a mounting example of the infrared sensor illustrated in FIG. 2;

FIG. 8 is a functional block diagram illustrating an example of the configuration of the display apparatus according to the embodiment of the disclosure;

FIG. 9 is a flowchart illustrating an example of a process of an operator identification unit illustrated in FIG. 8;

FIG. 10 illustrates an example of distance from each zone to a target measured by the infrared sensor when nobody approaches a display region;

FIG. 11 illustrates an example of distance from each zone to the target measured by the infrared sensor when an operator moves their hand closer to a first side (left-hand side) of a display region;

FIG. 12 illustrates an example of distance from each zone to the target measured by the infrared sensor when the operator moves their hand closer to a second side (right-hand side) of the display region;

FIG. 13 illustrates an example of a first image;

FIG. 14 illustrates an example of a second image;

FIG. 15 is a functional block diagram illustrating an example of the configuration of the display apparatus according to an embodiment of the disclosure;

FIG. 16 is a diagram illustrating an example of the configuration of the display apparatus according to an embodiment of the disclosure; and

FIG. 17 is a perspective view illustrating an example of the configuration of the display apparatus according to an embodiment of the disclosure.

### DESCRIPTION OF THE EMBODIMENTS

### First Embodiment

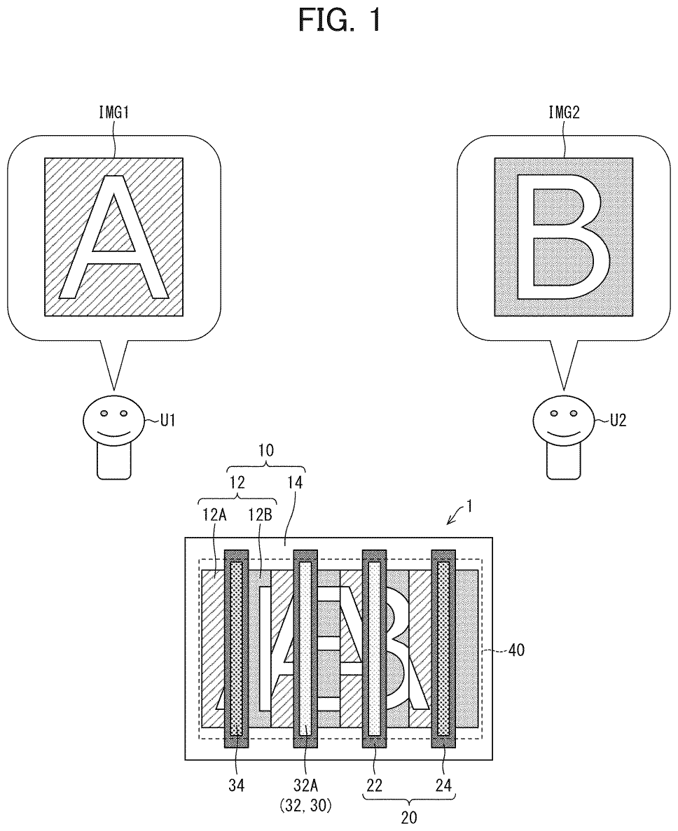

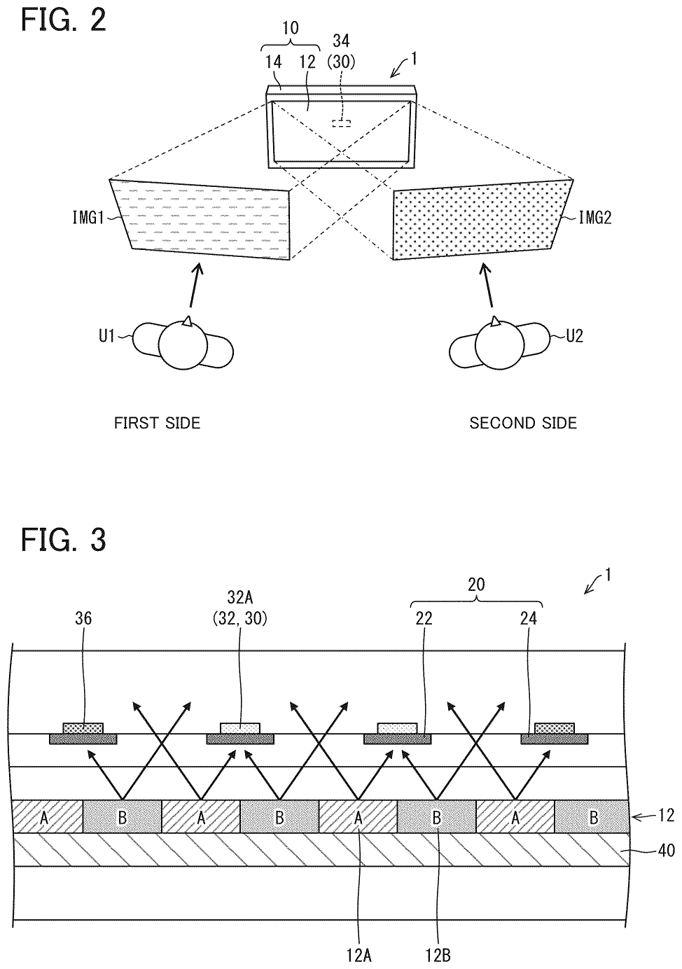

FIG. 1 illustrates users viewing a display apparatus 1 of a first embodiment of the disclosure together with a plan view of an example of the configuration of the display apparatus 1. FIG. 2 illustrates the users viewing the display apparatus of the first embodiment of the disclosure together with a plan view of another example of the configuration of the display apparatus. Referring to FIGS. 1 and 2, the display apparatus 1 of the first embodiment of the disclosure includes a display panel 10 having a display region 12 and a frame region 14 surrounding the display region 12, a proximity sensor 30 including one of a capacitive sensor 32 (see FIG. 1) and an infrared sensor 34 (see FIG. 2) and a touch sensor 40 that is superimposed on the display region 12 in a plan view.

FIG. 3 is a partial cross-sectional view illustrating an example of the configuration of the display apparatus 1 illustrated in FIG. 1. As illustrated in FIGS. 1 and 3, the capacitive sensor 32 includes multiple sensor electrodes 32A superimposed on the display region 12 in plan view and is enabled to detect approach of an operator to each of the sensor electrodes 32A. The capacitive sensor 32 may measure distance from each of the sensor electrodes 32A to a target in response to a change in capacitance of each of the sensor electrodes 32A with reference to the target. The target may be the body or hand of a user or the wall or ceiling of a room.

The display region 12 in the display panel 10 includes a first display region 12A displaying a first image IMG1 and a second display region 12B displaying a second image IMG2. The display apparatus 1 includes a light-blocking pattern 20 that is arranged in such a manner that the first image IMG1 is visible to a first user U1 who views the display panel 10 from a first side (left-hand side in FIG. 1) but the second image IMG2 is not visible to the first user U1 and that the first image IMG1 is not visible to a second user U2 who views the display panel 10 from a second side (right-hand side in FIG. 1) opposite to the first side but the second image IMG2 is visible to the second user U2. The sensor electrodes 32A in the capacitive sensor 32 are arranged to be superimposed on the light-blocking pattern 20 in a plan view.

The light-blocking pattern 20 may include multiple first light-blocking parts 22 and one or more second light-blocking parts 24. The sensor electrodes 32A may be respectively arranged on (or beneath) the first light-blocking parts 22 and dummy electrodes 36 that are electrically isolated may be respectively arranged on (or beneath) the second light-blocking parts 24.

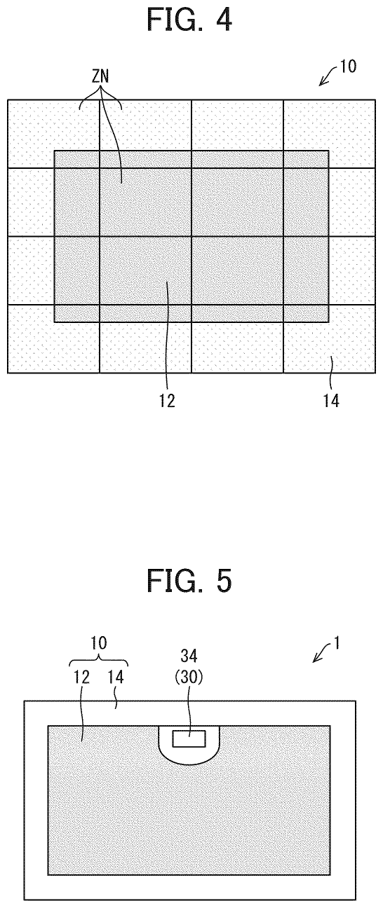

FIG. 4 is a diagram illustrating an example of zone segmentation performed by the infrared sensor 34 illustrated in FIG. 2. Referring to FIG. 4, the display region 12 is segmented into multiple zones ZN and the infrared sensor 34 is enabled to detect the approach of the operator to each zone ZN. An area including the display region 12 and the frame region 14 may be segmented into the zones ZN and the infrared sensor 34 is enabled to detect the approach of the operator to each zone ZN. The infrared sensor 34 may measure distance from each zone ZN to the target in accordance with infrared light that is reflected from the target via each of the zones ZN. The target may be the body or hand of the user or the wall or ceiling of the room.

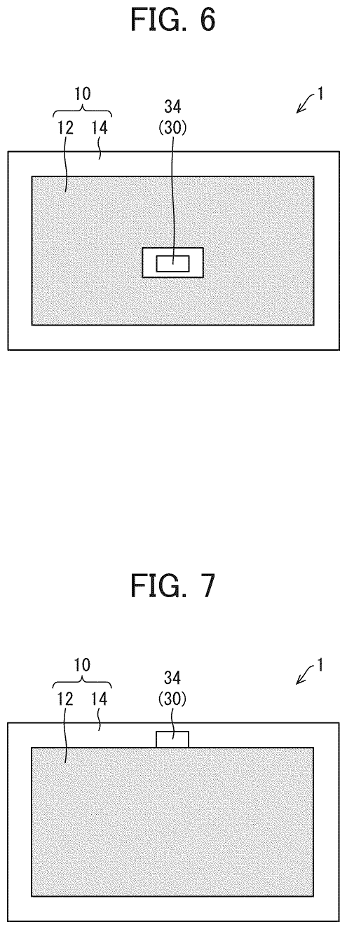

FIGS. 5 through 7 are plan views illustrating mounting examples of the infrared sensor 34 illustrated in FIG. 2. Referring to FIG. 5, the display region 12 bordering the frame region 14 may be cut and the infrared sensor 34 may be placed in the cutout portion of the display region 12. Referring to FIG. 6, the infrared sensor 34 may be placed in the display region 12. Referring to FIG. 7, the infrared sensor 34 may be placed in the frame region 14 bordering the display region 12.

The first user U1 and/or the second user U2 may operate the display apparatus 1 using the touch sensor 40 in any of the configurations described above. In the disclosure, a user who is about to operate the display apparatus 1 using the touch sensor 40 and/or who is operating the display apparatus 1 using the touch sensor 40 is referred to as an “operator.”

In the configurations described above, the proximity sensor 30 may be the capacitive sensor 32 superimposed on the display region 12 in a plan view or the infrared sensor 34 enabled to detect multiple zones. The frame region of the display apparatus 1 may be thus narrowed in comparison with the configuration in which multiple sensors unable to detect the multiple zones are arranged in the frame region (such as in the configuration disclosed in Japanese Unexamined Patent Application Publication No. 2009-241707).

In the configuration in which multiple sensors unable to detect the multiple zones are arranged in the frame region (such as in the configuration disclosed in Japanese Unexamined Patent Application Publication No. 2009-241707), as the display region is larger, detecting the approach of the operator to the central portion of the display region becomes more difficult and thus size increase in the display region becomes more difficult.

In the configuration of the first embodiment of the disclosure, the proximity sensor 30 may detect the approach of the operator to the whole area of the display region 12. The proximity sensor 30 measures the distance between each sensor electrode 32A or each zone ZN and the target. The sensor electrodes 32A are arranged in the display region 12 in a plan view and the zones ZN cover the whole display region 12 in a plan view. Even if the display region 12 is larger, the approach to the central portion of the display region 12 may be detected and the display apparatus 1 may be increased in screen size.

Referring to FIGS. 1 and 2, the display panel 10 may enable a single-view setting by equalizing the second image IMG2 to the first image IMG1 such that the first user U1 and the second user U2 view the same view. The display panel 10 may enable a multi-view setting by causing the first user U1 to view the first image IMG1 and the second user U2 to view the second image IMG2 different from the first image IMG1. The multi view include a dual view.

### Configuration of Controller

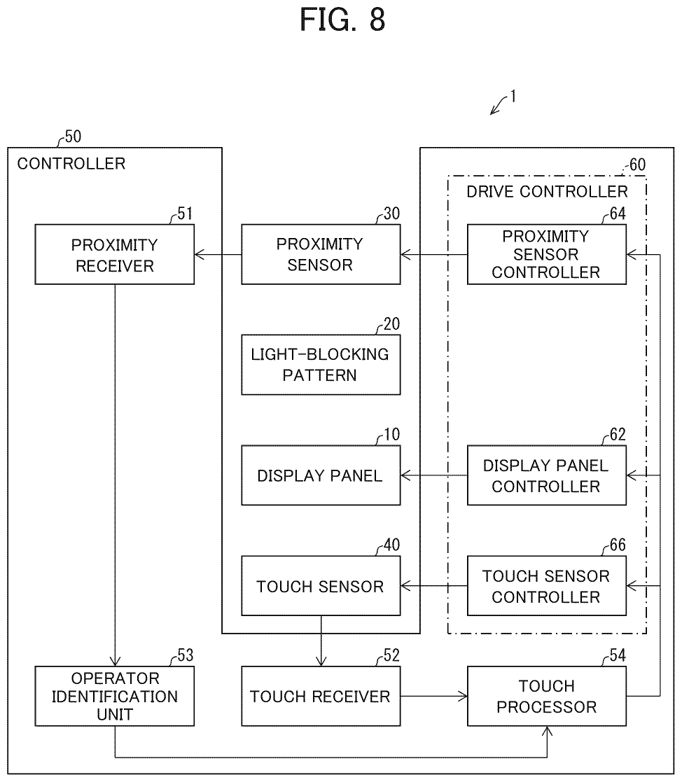

FIG. 8 is a functional block diagram illustrating an example of the configuration of the display apparatus 1 according to the first embodiment of the disclosure. Referring to FIG. 8, the display apparatus 1 of the first embodiment of the disclosure further includes a controller 50.

The controller 50 includes a proximity receiver 51 that receives proximity information from the proximity sensor 30, a touch receiver 52 that receives touch information from the touch sensor 40, an operator identification unit 53 that identifies in accordance with the proximity information whether an operator is the first user U1 who views the display panel 10 from a first side or the second user U2 who views the display panel 10 from a second side opposite to the first side, and a touch processor 54 that performs a first process corresponding to the touch information if the operator is identified to be the first user U1 or a second process corresponding to the touch information if the operator is identified to be the second user U2 with the second process at least partially different from the first process.

In the configuration described above, the controller 50 may differentiate a touch operation performed by the first user U1 from a touch operation performed by the second user U2 and may provide the first process or the second process different from the first process. Furthermore, false detection of the touch sensor 40 caused by noise is not associated with the proximity information indicating the approach of the operator and may thus be avoided.

The proximity receiver 51 may be a simple port that transmits to the operator identification unit 53 the proximity information, as is, from the proximity sensor 30 or alternatively the proximity receiver 51 may perform a process on the proximity information and then transmit the processed proximity information to the operator identification unit 53. For example, the proximity receiver 51 may perform a process, such as analog-to-digital conversion on the proximity information or determination as to whether the target closer to the display apparatus 1 than the threshold is present. If the proximity sensor 30 is the capacitive sensor 32, the proximity information may indicate the distance from each sensor electrode 32A to the target. If the proximity sensor 30 is the infrared sensor 34, the proximity information may indicate the distance from each zone ZN to the target. Layout information indicating the locations of the sensor electrodes 32A or the zones ZN may be recorded on a memory medium which is accessible to the controller 50.

The operator identification unit 53 receives the proximity information from the proximity receiver 51 and identifies in accordance with the proximity information and layout information whether the operator is the first user U1 or the second user U2. The operator identification unit 53 may also identify in accordance with the proximity information and layout information whether the operator is present. The operator identification unit 53 transmits operator information indicating the operator to the touch processor 54.

The touch receiver 52 may be a simple port that transmits to the touch processor 54 the touch information, as is, from the touch sensor 40 or alternatively the touch receiver 52 may perform a process on the touch information and then transmit the processed touch information to the touch processor 54. The touch information may indicate the position in the display apparatus 1 where the operator has touched.

The touch processor 54 determines in accordance with the operator information from the operator identification unit 53 whether the operator is the first user U1 or the second user U2. The touch processor 54 performs the first process in response to a touch operation performed by the first user U1 or the second process in response to a touch operation performed by the second user U2.

The controller 50 may include a drive controller 60 and the drive controller 60 may include a display panel controller 62 that controls the display panel 10, a proximity sensor controller 64 that controls the proximity sensor 30, and a touch sensor controller 66 that controls the touch sensor 40.

The display panel controller 62 may control the display panel 10 such that the single-view setting is performed (i) when the operator does not perform the touch operation, namely, when the touch receiver 52 has not received the touch information or the multi-view setting is performed (ii) when the operator performs the touch operation, namely, when the touch receiver 52 has received the touch information. To address false detection of the touch sensor 40, the multi-view setting may be performed when the operator identification unit 53 has determined that the operator is present and the touch receiver 52 has received the touch information or the single-view setting may be performed in other cases. The computation load of the controller 50 in the display apparatus 1 may be reduced by performing the single-view setting when the touch operation is not performed. By performing the multi-view setting when the touch operation is performed, the display apparatus 1 may display an image in response to the touch operation of the operator and a different image to a non-operator at the same time.

Conversely, the display panel controller 62 may control the display panel 10 such that the multi-view setting is performed (i) when the operator does not perform the touch operation or the single-view setting is performed (ii) when the operator performs the touch operation.

The display panel controller 62 may also control the display panel 10 such that the single-view setting is performed (i) when a user is away from the display apparatus 1, namely, when the operator identification unit 53 has determined in accordance with the proximity information that the operator is not present, or (ii) the multi-view setting is performed when the user is closer to the display apparatus 1, namely, when the operator identification unit 53 has determined in accordance with the proximity information that the operator is present. The computation load of the controller 50 in the display apparatus 1 may be reduced by performing the single-view setting when nobody is closer to the display region 12. By performing the multi-view setting when a person is closer to the display region 12, the display apparatus 1 may display an image prompting a nearby person to perform the touch operation and a different image to a non-operator at the same time.

Conversely, the display panel controller 62 may control the display panel 10 such that the multi-view setting is performed when the user is away from the display apparatus 1 or the single-view setting is performed when the user is closer to the display apparatus 1.

The first process and second process performed by the touch processor 54 may be different in terms of instruction to the display panel controller 62. For example, the first process may include switching the first image IMG1 while the second process may include switching the second image IMG2. In this way, the first user U1 may switch the first image IMG1 by the touch operation and the second user U2 may switch the second image IMG2 by the touch operation.

In addition to or instead of the foregoing, the first process and second process may be different in terms of another feature. For example, the first process and second process may be different in terms of one or more of an instruction to the proximity sensor controller 64, an instruction to the touch sensor controller 66 and an instruction to an external apparatus, such as a loudspeaker and air conditioning equipment.

### Process of Operator Identification Unit

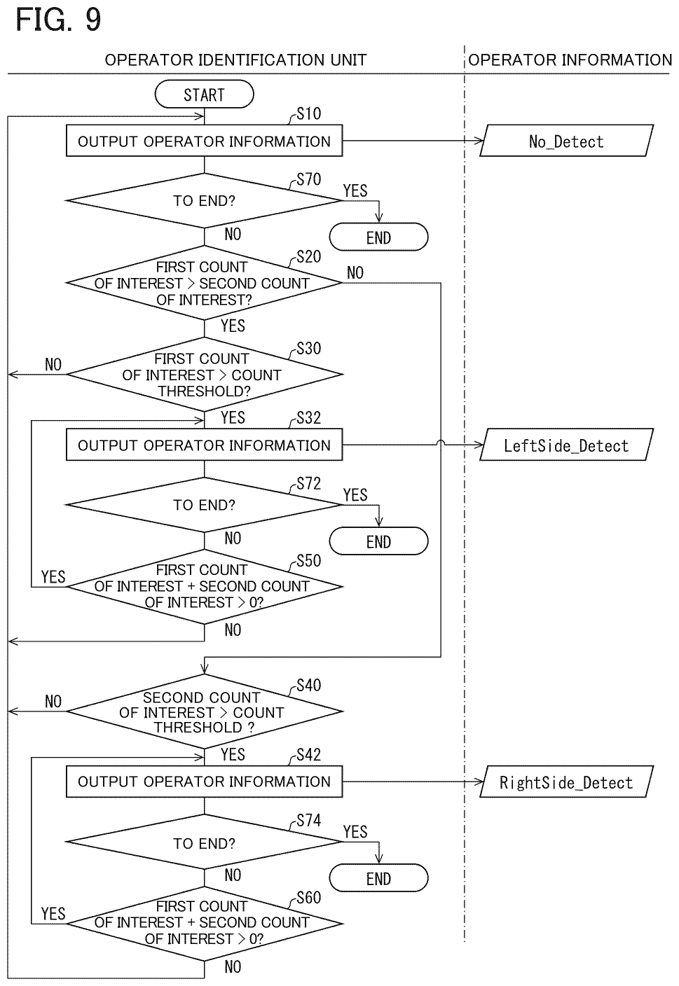

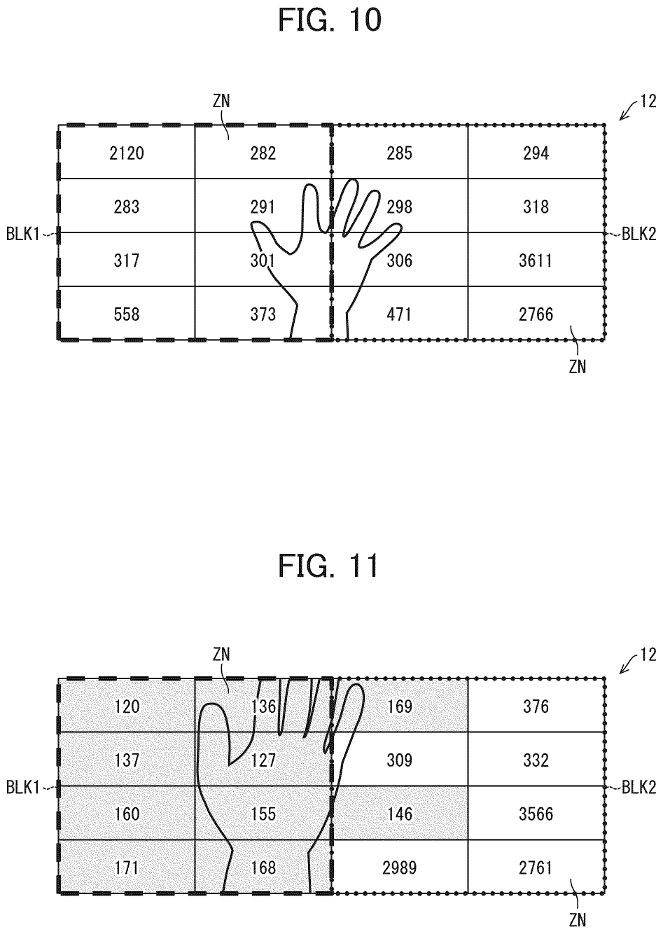

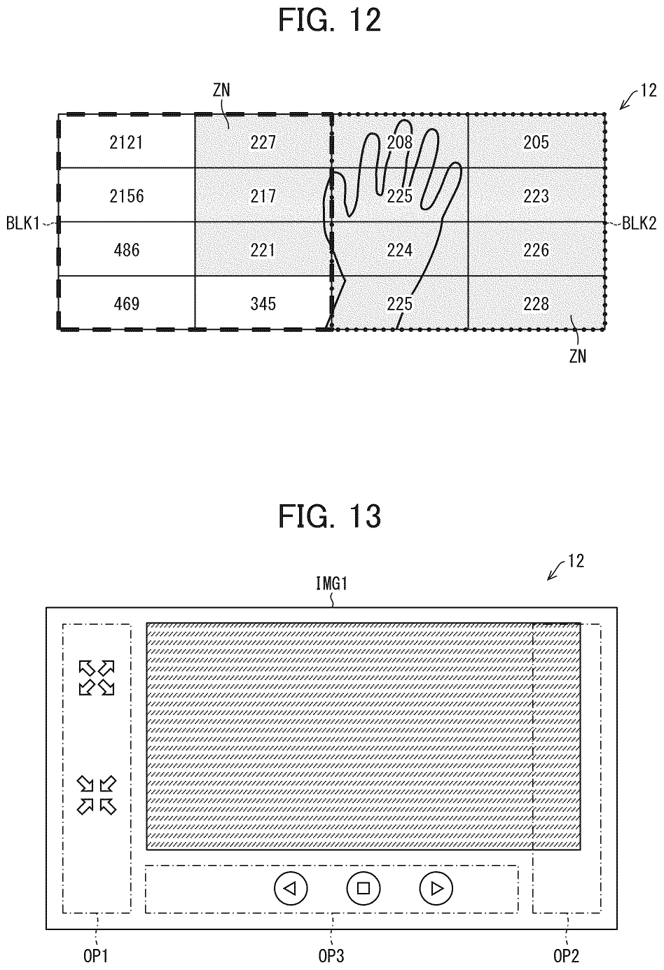

FIG. 9 is a flowchart illustrating an example of a process of the operator identification unit 53 illustrated in FIG. 8. FIG. 10 illustrates an example of the distance from each zone ZN to a target measured by the infrared sensor 34 when nobody approaches a display region. FIG. 11 illustrates an example of the distance from each zone ZN to the target measured by the infrared sensor 34 when an operator moves their hand closer to a first side (left-hand side) of the display region 12. FIG. 12 illustrates an example of the distance from each zone ZN to the target measured by the infrared sensor 34 when the operator moves their hand closer to a second side (right-hand side) of the display region 12.

In FIGS. 10 through 12, the unit of distance is mm and the proximity sensor 30 is the infrared sensor 34. The zones ZN include a first zone group BLK1 positioned to a first side (left-hand side) with respect to the center of the display region 12 and a second zone group BLK2 positioned to a second side (right-hand side) with respect to the center of the display region 12. A threshold (distance threshold) according to which the target is determined to be closer to a zone ZN is set in each zone ZN.

The number of zones ZN having a measurement distance equal to or below a distance threshold in the first zone group BLK1 is referred to as a first count of interest and the number of zones ZN having a measurement distance equal to or below a distance threshold in the second zone group BLK2 is referred to as a second count of interest. The distance threshold (count threshold) is set for each of the first count of interest in the first zone group BLK1 and the second count of interest in the second zone group BLK2.

In the process example described herein, the distance threshold in any zone ZN is 250 mm and the count threshold is four both in the first zone group BLK1 and the second zone group BLK2.

Referring to FIG. 9, the operator identification unit 53 outputs operator information “No Detect” indicating at a default state that the operator is not present and that neither the first user U1 nor the second user U2 is the operator (step S10). This may reduce the possibility that the touch processor 54 erratically performs the first process or the second process.

When the operator information “No Detect” is output, the operator identification unit 53 calculates the first count of interest and the second count of interest and determines whether the first count of interest is higher than the second count of interest (step S20).

If the relationship of the first count of interest>the second count of interest holds true (Yes in step S20), the operator identification unit 53 determines whether the first count of interest is higher than the count threshold (step S30). If the relationship of the first count of interest>the count threshold holds true (Yes in step S30), the operator identification unit 53 outputs operator information “LeftSide_Detect” indicating that the operator is present and that the first user U1 is the operator (step S32).

When the operator moves their hand closer to a first side of the display region 12 as illustrated in FIG. 11, the first count of interest is eight and the second count of interest is two. The relationship of the first count of interest>the second count of interest and the first count of interest>the count threshold holds true then and the operator identification unit 53 outputs the operator information “LeftSide_Detect.”

If the relationship of the first count of interest≤the second count of interest holds true (No in step S20), the operator identification unit 53 determines whether the second count of interest is higher than the count threshold (step S40). If the relationship of the second count of interest>the count threshold (Yes in step S40), the operator identification unit 53 outputs the operator information “RightSide_Detect” indicating that the operator is present and that the second user U2 is the operator (step S42).

When the operator moves their hand closer to a second side of the display region 12 as illustrated in FIG. 12, the first count of interest is three and the second count of interest is eight. The relationship of the first count of interest≤the second count of interest and the second count of interest>the count threshold holds true then and the operator identification unit 53 outputs the operator information “RightSide_Detect.”

If the determination result is no in step S30 or step S40, each of the first count of interest and the second count of interest is equal to or below the count threshold. The operator identification unit 53 thus returns to step S10 and continues outputting the operator information “No_Detect.”

When the user's hand is away from the display region 12 as illustrated in FIG. 10, the first count of interest and the second count of interest are zero and the operator identification unit 53 outputs the operator information “No_Detect.”

When the operator information “LeftSide_Detect” is output, the operator identification unit 53 calculates the sum of the first count of interest and the second count of interest and determines whether the sum of the first count of interest and the second count of interest is higher than zero (step S50). If the relationship of the first count of interest+the second count of interest>0 (Yes in step S50), the operator identification unit 53 returns to step S32 and continues outputting the operator information “LeftSide_Detect.”

When the operator information “RightSide_Detect” is output, the operator identification unit 53 also calculates the sum of the first count of interest and the second count of interest and determines whether the sum of the first count of interest and the second count of interest is higher than zero (step S60). If the relationship of the first count of interest+the second count of interest>0 (Yes in step S60), the operator identification unit 53 returns to step S42 and continues outputting the operator information “LeftSide_Detect.”

If the determination result is no in step S50 or step S60, each of the first count of interest and the second count of interest is zero. The operator identification unit 53 thus returns to step S10 to output the operator information “No Detect.”

The operator identification unit 53 appropriately determines whether to end the process (steps S70, S72 and S74).

### Process of Touch Processor

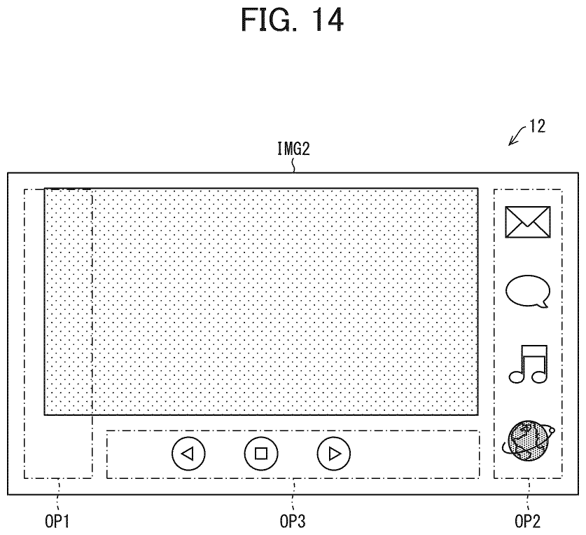

FIG. 13 illustrates the example of a first image. FIG. 14 illustrates the example of a second image. Referring to FIGS. 13 and 14, the display region 12 may include a first operation area OP1 (i) where the touch operation of the first user U1 is operative while the touch operation of the second user U2 is inoperative, a second operation area OP2 (ii) where the touch operation of the first user U1 is inoperative while the touch operation the second user U2 is operative, and a third operation area OP3 (iii) where the touch operation of the first user U1 and the touch operation of the second user U2 are operative. In the other areas, the touching operations of the first user U1 and the second user U2 are inoperative. The area where the touch operation is inoperative area is referred to as an inoperative area.

When the operator identification unit 53 feeds to the touch processor 54 the operator information indicating that the first user U1 is the operator, the touch processor 54 switches the first image IMG1 as illustrated in FIG. 13 in response to the touch operation in the first operation area OP1 and the third operation area OP3. The touch operation on the second operation area OP2 and the inoperative area does not switch the first image IMG1.

When the operator identification unit 53 feeds to the touch processor 54 the operator information indicating that the second user U2 is the operator, the touch processor 54 switches the second image IMG2 as illustrated in FIG. 14 in response to the touch operation in the second operation area OP2 and the third operation area OP3. The touch operation on the first operation area OP1 and the inoperative area does not switch the second image IMG2.

With the first image IMG1 different from the second image IMG2, there are times when the second user U2 may not have to be aware the operation contents of the first user U1 and the first user U1 may not have to be aware of the operation contents of the second user U2. For example, when the first user U1 views map information and the second user U2 enjoys contents including a video and music, the first user U1 and second user U2 may not have to aware of each other's operation contents. In such a case, icons or virtual buttons present in the first operation area OP1 and the third operation area OP3 in the first image IMG1 may not have to be displayed in the second image IMG2 and icons or virtual buttons present in the second operation area OP2 and the third operation area OP3 in the second image IMG2 may not have to be displayed in the first image IMG1.

### Triple-View Setting

The display panel 10 in the display apparatus 1 may enable a triple-view setting that allows, to view a third image different from the first image IMG1 and the second image IMG2, a third user who views the display panel 10 from a location different from the locations of the first user U1 and the second user U2. When the triple-view setting is operative, the operator identification unit 53 may identify whether the operator is the first user U1, the second user U2 or the third user.

If the display panel 10 is capable of displaying different images respectively to four or more users, the operator identification unit 53 may identify each of the four or more users.

### Second Embodiment

### Configuration of Controller

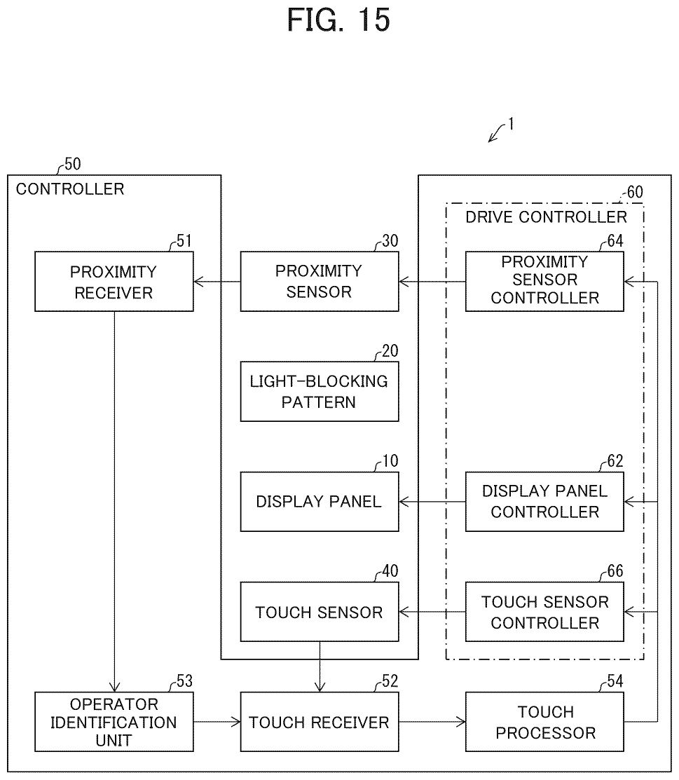

FIG. 15 is a functional block diagram illustrating an example of the configuration of the display apparatus 1 according to a second embodiment of the disclosure. Referring to FIG. 15, the operator identification unit 53 of the second embodiment of the disclosure transmits the operator information indicative of the operator to the touch receiver 52.

When the operator identification unit 53 identifies the operator to be the first user U1, the touch receiver 52 links the touch information to a first detection flag in accordance with the operator information. When the operator identification unit 53 identifies the operator to be the second user U2, the touch receiver 52 links the touch information to a second detection flag in accordance with the operator information.

The touch processor 54 performs the first process on the touch information linked to the first detection flag and the second process on the touch information linked to the second detection flag and ignores the touch information that is linked to none of the first detection flag and the second detection flag.

In the configuration described above, an erroneous process may be reduced. In the method in which the touch processor 54 is supplied with the operator information as illustrated in FIG. 8, an unexpected time lag may occur between the touch information supplied to the touch processor 54 at a given time point and the proximity information that serves as a basis of the operator information supplied to the touch processor 54 at that given time point. Such a time lag may lead to an erroneous process, such as the touch processor 54 performing the first process, if the second user U2 performs the touch operation immediately after the first user U1 approaches. In contrast, in the method in which the operator information is supplied to the touch receiver 52 as illustrated in FIG. 9, the touch information is linked to the first detection flag and the second detection flag. This may reduce the possibility that the unexpected time lag occurs between the touch information and the proximity information serving as a basis of the detection flag. In the configuration of the second embodiment, the erroneous process may be reduced.

### Third Embodiment

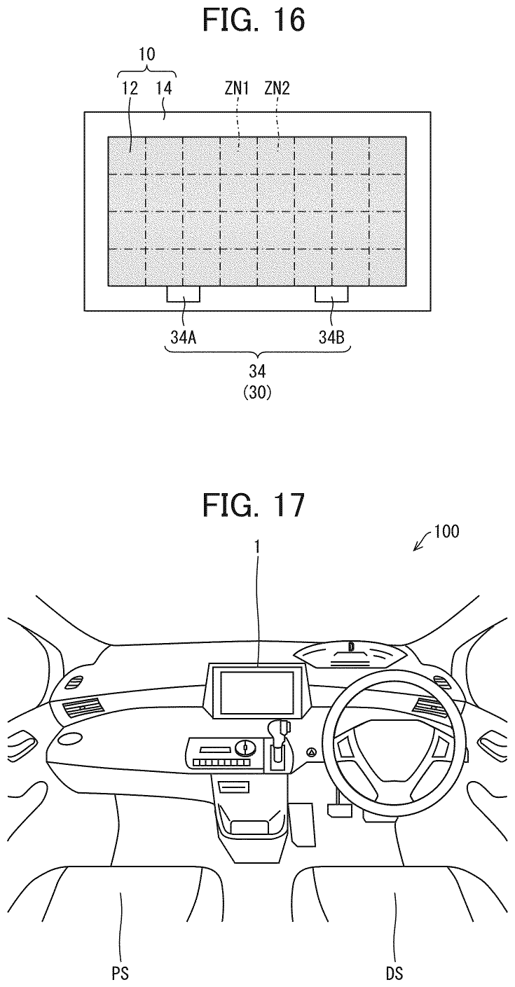

FIG. 16 is a diagram illustrating an example of the configuration of the display apparatus 1 according to a third embodiment of the disclosure. Referring to FIG. 16, the proximity sensor 30 may include multiple infrared sensors 34. Detection areas of the infrared sensor 34 are different from each other and cover the entire area of the display region. For example, the proximity sensors 30 may include a first infrared sensor 34A (i) that is enabled to detect approach of the operator to each of first zones ZN1 into which an area of a first side with respect to the center of the display region 12 is segmented and a second infrared sensor 34B (ii) that is enabled to detect approach of the operator to each of second zones ZN2 into which an area of a second side with respect to the center of the display region 12 is segmented.

In the configuration described above, the proximity sensor 30 includes multiple infrared sensors 34 enabled to detect multi-zones. The frame portion of the display apparatus 1 may be narrowed in comparison with the related art configuration without sensors enabled to detect the multi-zones (Japanese Unexamined Patent Application Publication No. 2009-241707).

The area that the multiple infrared sensors 34 are enabled to detect is larger than the area that a single infrared sensor 34 is enabled to detect. The area of the display region 12 may thus be increased.

The number of zones segmented by the multiple infrared sensors 34 is higher than the number of zones segmented by the single infrared sensor 34. The display region 12 may thus be more finely segmented, leading to an increase in identification accuracy of the operator identification unit 53.

The infrared sensors 34 may be arranged such that the infrared sensors 34 cover each other's blind spots. Such an arrangement may lead to an increase in the identification accuracy of the operator identification unit 53. The infrared sensors 34 may mutually overlap each other in the detection region.

The configuration of the third embodiment may be combined with the configurations of the first and second embodiments.

### Implementation Example Using Software

The above-described functions of the controller 50 in the display apparatus 1 may be implemented by a program that causes a computer to operate as the controller 50. Specifically, the program causes the computer to operate as the functional blocks of the controller 50 (including the proximity receiver 51, touch receiver 52, operator identification unit 53, touch processor 54, proximity sensor controller 64, display panel controller 62 and touch sensor controller 66).

The controller 50 includes, as a hardware component to execute the program, a computer that includes at least one control device (such as a processor or a microcomputer) and at least one storage (such as a memory). The functional blocks described with reference to the embodiments are implemented when the control device and storage perform the program.

The program may be stored on one or more non-transitory computer-readable recording media. The control device may or may not include a recording medium. If the control device includes no recording medium, the program may be downloaded to the control device via any wireless or wired transmission medium.

Some or all of the functions of the functional blocks may be implemented using a logic circuit. For example, an integrated circuit including the logic circuit that functions as the functional blocks falls within the scope of an embodiment of the disclosure. Furthermore, the functions of the functional blocks may be implemented using a quantum computer.

The processes described with reference to the embodiments may be implemented using artificial intelligence (AI). In such a case, AI may operate on the control device (such as a processor or a microcomputer) or on another apparatus (such as an edge computer or a cloud server).

### Fourth Embodiment

FIG. 17 is a perspective view illustrating an example of the configuration of the display apparatus 1 according to a fourth embodiment of the disclosure. Referring to FIG. 17, the display apparatus 1 may be a vehicle display apparatus. The display apparatus 1 of the fourth embodiment may have one of the configurations of the first through third embodiments or a combination of two or more of the configurations of the first through third embodiment or a variation of each of the configurations. A vehicle 100 having the display apparatus 1 mounted thereon falls within the scope of the disclosure.

The display apparatus 1 may be mounted on the vehicle 100 in view of the situation where the first user U1 sits in the driver's seat DS while the second user U2 sits in the passenger's seat PS. Alternatively, the display apparatus 1 is mounted on the vehicle 100 in view of the situation where the first user U1 sits in the passenger's seat PS while the second user U2 sits in the driver's seat DS.

### CONCLUSION

According to a first aspect of the disclosure, there is provided a display apparatus including: a display panel including a display region; a proximity sensor including (i) a capacitive sensor having a plurality of sensor electrodes superimposed on the display region in a plan view and enabled to detect approach of an operator to each of the sensor electrodes or (ii) an infrared sensor enabled to detect the approach of the operator to each of zones into which the display region is segmented; a touch sensor superimposed on the display region in a plan view; and a controller, wherein the controller includes a proximity receiver that receives proximity information from the proximity sensor; a touch receiver that receives touch information from the touch sensor; an operator identification unit that determines in accordance with the proximity information whether the operator is a first user who views the display panel from a first side or a second user who views the display panel from a second side opposite to the first side; and a touch processor that performs a first process corresponding to the touch information if the operator is identified to be the first user or a second process corresponding to the touch information if the operator is identified to be the second user, with the second process at least partially different from the first process.

In the display apparatus according to a second aspect of the disclosure in view of the first aspect, the touch receiver may link the touch information to a first detection flag if the operator identification unit has determined the operator to be the first user, the touch receiver may link the touch information to a second detection flag if the operator identification unit has determined the operator to be the second user, and the touch processor may perform the first process on the touch information linked to the first detection flag, may perform the second process on the touch information linked to the second detection flag and may ignore the touch information that is linked to none of the first detection flag and the second detection flag.

In the display apparatus according to a third aspect of the disclosure in view of one of the first and second aspects, the display panel may enable a single-view setting that causes the first user and the second user to view the same image and a multi-view setting that causes the first user to view a first image and the second user to view a second image different from the first image.

In the display apparatus according to a fourth aspect of the disclosure in view of the third aspect, the controller may further include a display panel controller that controls the display panel such that the single-view setting is performed if the touch receiver has not received the touch information and such that the multi-view setting is performed if the touch receiver has received the touch information.

In the display apparatus according to a fifth aspect of the disclosure in view of one of the first through fourth aspects, the first process may include switching the first image and the second process may include switching the second image.

In the display apparatus according to a sixth aspect of the disclosure in view of one of the third and fourth aspects or in view of the fifth aspect that refers to one of the third and fourth aspects, the controller may further include a display panel controller that controls the display panel to perform (i) the single-view setting if the operator identification unit has determined in accordance with the proximity information that the operator is not present or (ii) the multi-view setting if the operator identification unit has determined in accordance with the proximity information that the operator is present.

In the display apparatus according to a seventh aspect of the disclosure in view of one of the first through sixth aspects, the proximity sensor may include a plurality of the infrared sensors and wherein detection ranges of the infrared sensors may be different from each other and cover the entire area of the display region.

The display apparatus according to an eight aspect of the disclosure in view of one of the first through seventh aspects may be a vehicle display apparatus.

According to a ninth aspect of the disclosure, there is provided a vehicle including the display apparatus according to one of the first through eighth aspects, wherein the first user sits in a driver's seat and the second user sits in a passenger's seat.

The present disclosure contains subject matter related to that disclosed in Japanese Priority Patent Application JP 2024-147926 filed in the Japan Patent Office on Aug. 29, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

### APPENDIX

The disclosure is not limited to the embodiments described above, and a variety of changes are possible within the scope described with reference to the claims, and an embodiment obtained by combining techniques described in the different embodiments also falls within the scope of the disclosure. A new technical feature may be formed by combining the techniques disclosed in the embodiments.

What is claimed is:

1. A display apparatus comprising: a display panel including a display region; a proximity sensor including (i) a capacitive sensor having a plurality of sensor electrodes superimposed on the display region in a plan view and enabled to detect approach of an operator to each of the sensor electrodes or (ii) an infrared sensor enabled to detect the approach of the operator to each of zones into which the display region is segmented; a touch sensor superimposed on the display region in a plan view; and a controller, wherein the controller includes a proximity receiver that receives proximity information from the proximity sensor; a touch receiver that receives touch information from the touch sensor; an operator identification unit that determines in accordance with the proximity information whether the operator is a first user who views the display panel from a first side or a second user who views the display panel from a second side opposite to the first side; and a touch processor that performs a first process corresponding to the touch information if the operator is identified to be the first user or a second process corresponding to the touch information if the operator is identified to be the second user, with the second process at least partially different from the first process.

2. The display apparatus according to claim 1, wherein the touch receiver links the touch information to a first detection flag if the operator identification unit has determined the operator to be the first user, the touch receiver links the touch information to a second detection flag if the operator identification unit has determined the operator to be the second user, and the touch processor performs the first process on the touch information linked to the first detection flag, performs the second process on the touch information linked to the second detection flag and ignores the touch information that is linked to none of the first detection flag and the second detection flag.

3. The display apparatus according to claim 1, wherein the display panel enables a single-view setting that causes the first user and the second user to view a same image and a multi-view setting that causes the first user to view a first image and the second user to view a second image different from the first image.

4. The display apparatus according to claim 3, wherein the controller further comprises a display panel controller that controls the display panel such that the single-view setting is performed if the touch receiver has not received the touch information and such that the multi-view setting is performed if the touch receiver has received the touch information.

5. The display apparatus according to claim 4, wherein the first process includes switching the first image and the second process includes switching the second image.

6. The display apparatus according to claim 3, wherein the controller further includes a display panel controller that controls the display panel to perform (i) the single-view setting if the operator identification unit has determined in accordance with the proximity information that the operator is not present or (ii) the multi-view setting if the operator identification unit has determined in accordance with the proximity information that the operator is present.

7. The display apparatus according to claim 6, wherein the proximity sensor comprises a plurality of the infrared sensors and wherein detection ranges of the infrared sensors are different from each other and cover an entire area of the display region.

8. The display apparatus according to claim 1 being a vehicle display apparatus.

9. A vehicle comprising the display apparatus according to claim 1, wherein the first user sits in a driver's seat and the second user sits in a passenger's seat.
